(19) United States
(12) Patent Application Publication
(10) Pub. No.: US 2026/0079504 A1
(43) Pub. Date: Mar. 19, 2026

(54) Systems and Methods For Coordinating Multi-Agent Swarms of Autonomous Ground Vehicles

(71) Applicant: Swarmbotics AI, Inc., Scottsdale, AZ (US)

(72) Inventors: Justin Kottinger, Scottsdale, AZ (US); Andrew Watson, Scottsdale, AZ (US)

(73) Assignee: Swarmbotics AI, Inc., Scottsdale, AZ (US)

(21) Appl. No.: 18/890,439

(22) Filed: Sep. 19, 2024

(51) Int. Cl. G05D 1/698; G05D 1/644

(52) U.S. Cl. CPC G05D 1/6987; G05D 1/644

(57) ABSTRACT

The present disclosure provides an autonomous ground vehicle system configured to be deployed in and coordinate with a multi-agent swarm of autonomous ground vehicles. The system includes one or more processors, one or more memories, one or more wireless communication modules, one or more motors, and one or more sensors configured to observe an environment through which the autonomous ground vehicle system navigates. The system is configured to receive a multi-agent behavior request requiring multiple agents to be performed, translate the request into one or more tasks each configured to be performed by a single agent, assign at least a first task to the autonomous ground vehicle system based on a cost function indicating efficiency, and autonomously execute the first task causing the system to navigate through the environment using the sensors and motor.

### FIELD OF THE DISCLOSURE

The present disclosure relates to systems and methods for coordinating multi-agent swarms of autonomous unmanned ground vehicles.

### BACKGROUND

Autonomous ground vehicles have become increasingly prevalent in various industries, including agriculture, logistics, and defense. These vehicles are designed to be unmanned and operate without direct human intervention, relying on advanced sensors, processors, and control systems to navigate and perform tasks in diverse environments. As the capabilities of autonomous ground vehicles continue to expand, there is a growing interest in deploying multiple such vehicles in coordinated swarms to accomplish complex missions more efficiently.

Multi-agent swarms of autonomous ground vehicles offer numerous potential advantages, including increased coverage area, redundancy, and the ability to tackle tasks that may be too large or complex for a single vehicle. However, coordinating the actions of multiple autonomous vehicles presents significant challenges. These challenges include effective communication between agents, task allocation, collision avoidance, and ensuring that the swarm as a whole achieves its objectives efficiently.

One of the key difficulties in managing multi-agent swarms is the development of robust and flexible control systems that can adapt to changing environments and mission parameters. Traditional centralized control approaches struggle to scale effectively as the number of agents in a swarm increases. Additionally, centralized systems can be vulnerable to single points of failure, potentially compromising the entire swarm's effectiveness.

Another challenge lies in translating high-level mission objectives into specific tasks that individual agents can execute. This process must account for the varying capabilities of different agents within the swarm, as well as the dynamic nature of the environment in which they operate. Furthermore, the system must be able to reassign tasks and adjust priorities in real-time as conditions change or unexpected obstacles arise.

Effective communication and coordination between agents in a swarm are critical for successful mission execution. However, maintaining reliable communication links in challenging environments, such as urban areas or remote locations with limited infrastructure, can be problematic. Systems must be designed to operate effectively even when communication is intermittent or degraded.

As the complexity of missions assigned to autonomous ground vehicle swarms increases, there is a growing need for more sophisticated methods of task allocation and execution. These methods must balance the overall mission objectives with the individual capabilities and constraints of each agent in the swarm, while also adapting to changing conditions in real-time.

### SUMMARY

The following description presents a simplified summary in order to provide a basic understanding of some aspects described herein. This summary is not an extensive overview of the claimed subject matter. It is intended to neither identify key or critical elements of the claimed subject matter nor delineate the scope thereof.

According to an aspect of the present disclosure, an autonomous ground vehicle system configured to be deployed in and coordinate with a multi-agent swarm of autonomous ground vehicles is provided. The autonomous ground vehicle system includes one or more processors, one or more memories, one or more wireless communication modules, one or more motors, and one or more sensors configured to observe an environment through which the autonomous ground vehicle system navigates. The system is configured to receive, via the one or more wireless communication modules, a multi-agent behavior request, the multi-agent behavior request requiring multiple agents to be performed. The system is further configured to translate the multi-agent behavior request into one or more tasks, each of the one or more tasks being configured to be performed by a single agent. The system is also configured to assign at least a first task of the one or more tasks to the autonomous ground vehicle system based, at least in part, on a cost function indicating that the first task is configured to be performed by the autonomous ground vehicle system more efficiently than by another agent in the multi-agent swarm of autonomous ground vehicles. Additionally, the system is configured to autonomously execute the first task, wherein autonomously executing the first task causes the autonomous ground vehicle system to navigate through the environment using the one or more sensors and the one or more motors.

According to other aspects of the present disclosure, the autonomous ground vehicle system may include one or more of the following features. The system may be further configured to translate the multi-agent behavior request into one or more constraints and autonomously execute the first task while adhering to the one or more constraints. The system may be further configured to translate the multi-agent behavior request by selecting a translation algorithm from a plurality of translation algorithms based on the multi-agent behavior request and applying the selected translation algorithm to generate the one or more tasks. The system may be further configured to translate the multi-agent behavior request by selecting a translation algorithm from a plurality of translation algorithms based on the multi-agent behavior request and applying the selected translation algorithm to generate one or more constraints. The translation of the multi-agent behavior request into the one or more tasks may be performed by each agent in the multi-agent swarm of autonomous ground vehicles, and each agent in the multi-agent swarm of autonomous ground vehicles may obtain the same result of translating the multi-agent behavior request into the one or more tasks.

The cost function may comprise each agent in the multi-agent swarm of autonomous ground vehicles making a bid on each task of the one or more tasks, communicating the bids between each agent in the multi-agent swarm of autonomous ground vehicles, and resolving conflicts to assign each task of the one or more tasks to one or more of the agents in the multi-agent swarm of autonomous ground vehicles. Each agent in the multi-agent swarm of autonomous ground vehicles making a bid on each task of the one or more tasks may comprise calculating a score for each task of the one or more tasks. The score for each task of the one or more tasks may be further based on capabilities of each respective autonomous ground vehicle of the multi-agent swarm of autonomous ground vehicles. The multi-agent swarm of autonomous ground vehicles may include at least a first autonomous ground vehicle and a second autonomous ground vehicle, wherein the second autonomous ground vehicle has at least one different capability relative to the first autonomous ground vehicle, and wherein making a bid on each task of the one or more tasks may comprise accounting for the at least one different capability when calculating the bid for one or more of the tasks. The system may be further configured to autonomously execute the first task by querying a navigation stack to determine navigation instructions for completing the first task and providing the navigation instructions to the autonomous ground vehicle system to execute the first task.

According to another aspect of the present disclosure, a method for operating an autonomous ground vehicle system configured to be deployed in and coordinate with a multi-agent swarm of autonomous ground vehicles is provided. The method includes receiving, via one or more wireless communication modules, a multi-agent behavior request, the multi-agent behavior request requiring multiple agents to be performed. The method further includes translating the multi-agent behavior request into one or more tasks, each of the one or more tasks being configured to be performed by a single agent. The method also includes assigning at least a first task of the one or more tasks to the autonomous ground vehicle system based, at least in part, on a cost function indicating that the first task is configured to be performed by the autonomous ground vehicle system more efficiently than by another agent in the multi-agent swarm of autonomous ground vehicles. Additionally, the method includes autonomously executing the first task, wherein autonomously executing the first task causes the autonomous ground vehicle system to navigate through an environment using one or more sensors and one or more motors.

According to other aspects of the present disclosure, the method may include one or more of the following features. The method may further comprise translating the multi-agent behavior request into one or more constraints and autonomously executing the first task while adhering to the one or more constraints. Translating the multi-agent behavior request may comprise selecting a translation algorithm from a plurality of translation algorithms based on the multi-agent behavior request and applying the selected translation algorithm to generate the one or more tasks. Translating the multi-agent behavior request may comprise selecting a translation algorithm from a plurality of translation algorithms based on the multi-agent behavior request and applying the selected translation algorithm to generate one or more constraints. The translation of the multi-agent behavior request into the one or more tasks may be performed by each agent in the multi-agent swarm of autonomous ground vehicles, and each agent in the multi-agent swarm of autonomous ground vehicles may obtain the same result of translating the multi-agent behavior request into the one or more tasks.

The cost function of the method may comprise each agent in the multi-agent swarm of autonomous ground vehicles making a bid on each task of the one or more tasks, communicating the bids between each agent in the multi-agent swarm of autonomous ground vehicles, and resolving conflicts to assign each task of the one or more tasks to one or more of the agents in the multi-agent swarm of autonomous ground vehicles. Each agent in the multi-agent swarm of autonomous ground vehicles making a bid on each task of the one or more tasks may comprise calculating a score for each task of the one or more tasks. The score for each task of the one or more tasks may be further based on capabilities of each respective autonomous ground vehicle of the multi-agent swarm of autonomous ground vehicles. The multi-agent swarm of autonomous ground vehicles may include at least a first autonomous ground vehicle and a second autonomous ground vehicle, wherein the second autonomous ground vehicle has at least one different capability relative to the first autonomous ground vehicle, and wherein making a bid on each task of the one or more tasks may comprise accounting for the at least one different capability when calculating the bid for one or more of the tasks. Autonomously executing the first task may comprise querying a navigation stack to determine navigation instructions for completing the first task and providing the navigation instructions to the autonomous ground vehicle system to execute the first task.

Further variations encompassed within the systems and methods are described in the detailed description of the invention below.

### BRIEF DESCRIPTION OF THE DRAWINGS

The accompanying drawings, which are incorporated in and constitute a part of this specification, show certain aspects of the subject matter disclosed herein and, together with the descriptions, help explain some of the principles associated with the disclosed implementations.

FIG. 1A depicts a perspective view of a first autonomous ground vehicle according to aspects of the present disclosure.

FIG. 1B depicts a side view of a second autonomous ground vehicle according to aspects of the present disclosure

FIG. 2 depicts a system diagram of an autonomous ground vehicle according to aspects of the present disclosure.

FIG. 3 depicts a system diagram of an autonomous ground vehicle network including a multi-agent swarm of autonomous ground vehicles according to aspects of the present disclosure.

FIG. 4 depicts a flowchart depicting a method for processing a behavior request by an agent of an autonomous ground vehicle within a multi-agent swarm of autonomous ground vehicles according to aspects of the present disclosure.

FIG. 5 depicts a system diagram of a multi-agent swarm of autonomous ground vehicles executing a line formation behavior according to aspects of the present disclosure.

FIG. 6 depicts a system diagram of a multi-agent swarm of autonomous ground vehicles executing a surround behavior according to aspects of the present disclosure.

FIG. 7 depicts a system diagram of a multi-agent swarm of autonomous ground vehicles executing a converge behavior according to aspects of the present disclosure.

FIG. 8 depicts a flowchart of a method for coordinating autonomous ground vehicles in a multi-agent swarm according to aspects of the present disclosure.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

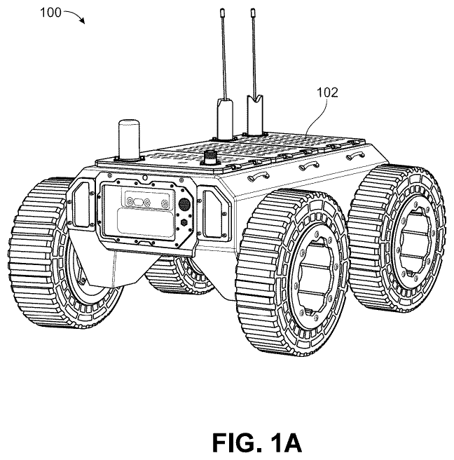

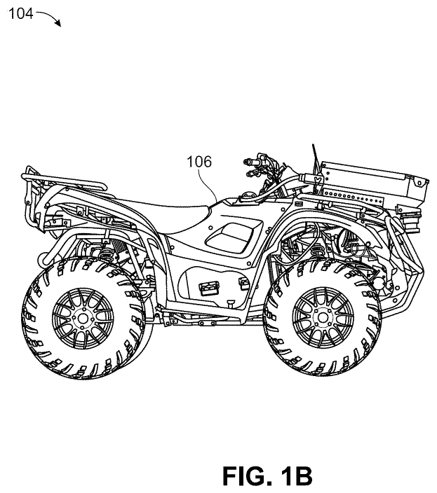

Referring to FIG. 1A, a diagram 100 showing a perspective view of an autonomous unmanned ground vehicle 102 is illustrated. Referring to FIG. 1B, a diagram 104 showing a side view of an autonomous ground vehicle 106 is illustrated. The autonomous unmanned ground vehicle 102 illustrated in FIG. 1 may serve as examples of different types of autonomous ground vehicles that can be utilized within the systems and methods of the present disclosure. However, it should be understood that the present disclosure is not limited to these specific configurations or designs. In some aspects, as described in greater detail below, the multi-agent swarm may include a variety of autonomous ground vehicles with different physical characteristics, capabilities, and features. These vehicles may vary in size, shape, propulsion systems, sensor configurations, and specialized equipment, depending on the specific requirements of the mission or operational environment. The systems and methods described herein may be adaptable to coordinate and manage diverse types of autonomous ground vehicles within a single swarm, potentially enhancing the overall versatility and effectiveness of the multi-agent system.

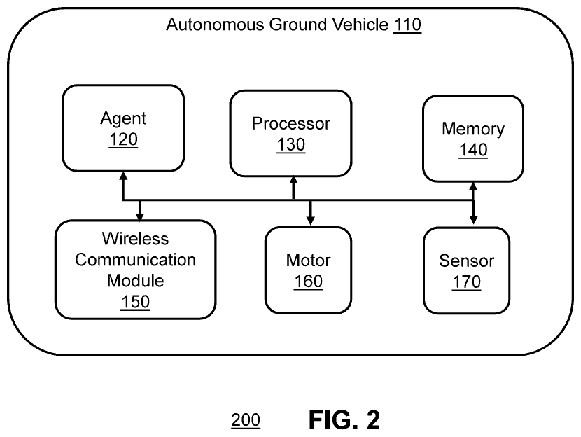

Referring to FIG. 2, a system diagram 200 of an autonomous unmanned ground vehicle 110 is illustrated. The autonomous ground vehicle 110 shown in FIG. 2 may represent the vehicles depicted in FIGS. 1A and/or 1B, or it may illustrate a different type of autonomous ground vehicle. In some aspects, the system diagram 200 may be applicable to various configurations of autonomous ground vehicles that can be utilized within the multi-agent swarm. As described in reference to FIG. 1, the present disclosure may accommodate a diverse range of autonomous ground vehicle designs and capabilities, allowing for flexibility in the composition of the swarm. In some cases, the specific components and arrangements shown in FIG. 2 may be adapted or modified to suit different vehicle types while still maintaining the core functionality required for participation in the multi-agent swarm. This versatility in vehicle types may enable the swarm to leverage a wide array of specialized capabilities and adapt to various mission requirements and environmental conditions.

The autonomous ground vehicle 110 includes several components that work together to enable its autonomous operation. These components include an agent 120, one or more processors 130, one or more memories 140, one or more wireless communication modules 150, one or more motors 160, and one or more sensors 170.

The processor 130 is configured to process data and execute instructions for the autonomous operation of the vehicle. The processor 130 is connected to the one or memory 140, which stores data and instructions for the system's operation.

The wireless communication module 150 enables the vehicle to communicate with other vehicles or external systems, allowing for coordination and data exchange. In some cases, the wireless communication module 150 may receive a multi-agent behavior request, which initiates a process of translating the request into one or more tasks and constraints, assigning the tasks to the autonomous ground vehicle 110 based on a cost function, and autonomously executing the tasks while adhering to the constraints inherent to the requested behavior.

The motor 160 provides the mechanical power for the vehicle's movement. In some aspects, the motor 160 is controlled by the processor 130 based on instructions from an agent 120, which serves as the central control unit for the autonomous ground vehicle 110.

The one or more sensors 170 are configured to observe the environment through which the autonomous ground vehicle 110 navigates. The sensors 170 collect data about the vehicle's environment and state, which is then processed by the processor 130 and used by the agent 120 for decision-making and navigation.

In some aspects, the one or more sensors 170 of the autonomous ground vehicle 110 may include a variety of sensor types to detect terrain, temperature, and other environmental conditions. These sensors may work in conjunction to provide comprehensive environmental data for navigation and decision-making.

For example, for terrain detection, the autonomous ground vehicle 110 may utilize LiDAR (Light Detection and Ranging) sensors. LiDAR sensors may emit laser pulses to measure distances to objects and create detailed 3D maps of the surrounding terrain. This may allow the vehicle to detect obstacles, uneven surfaces, and changes in elevation.

In some cases, the autonomous ground vehicle 110 may employ radar sensors for terrain mapping and obstacle detection. Radar sensors may use radio waves to detect objects and their distances, potentially providing reliable data even in low visibility conditions such as fog or dust. Ultrasonic sensors may be used for short-range obstacle detection.

In some aspects, the autonomous ground vehicle 110 may utilize stereo cameras to create three-dimensional maps of its environment. Stereo cameras may consist of two or more lenses with separate image sensors, allowing the system to capture multiple perspectives of the same scene. By analyzing the differences between these images, the system may calculate depth information and generate a 3D representation of the surrounding area.

For temperature sensing, the autonomous ground vehicle 110 may incorporate thermocouples or resistance temperature detectors (RTDs). These sensors may measure ambient air temperature, which may be beneficial for monitoring environmental conditions that could affect vehicle performance or mission parameters.

Infrared cameras may be employed for both terrain analysis and temperature sensing. These cameras may detect heat signatures, potentially allowing the vehicle to identify warm objects or assess surface temperatures of the terrain.

In some aspects, the vehicle may use moisture sensors to detect wet or muddy conditions that could affect traction or navigation. These sensors may help the vehicle adjust its behavior based on ground moisture levels.

Barometric pressure sensors may be included to detect changes in altitude or weather conditions. This data may be useful for navigation in varied terrains or for anticipating environmental changes that could impact the mission.

Accelerometers and gyroscopes may be utilized to measure the vehicle's orientation, acceleration, and vibration. These inertial measurement unit (IMU) sensors may provide data on the vehicle's movement and stability, which may be particularly useful when navigating rough or uneven terrain.

In some implementations, the autonomous ground vehicle 110 may include chemical sensors to detect the presence of specific substances in the air or on the ground. This capability may be useful for environmental monitoring missions or for detecting potential hazards.

The vehicle may also employ optical cameras for visual navigation and obstacle detection. These cameras may provide high-resolution images of the environment, which may be processed using computer vision algorithms to identify objects, assess terrain conditions, and aid in navigation.

By incorporating a diverse array of sensors, the autonomous ground vehicle 110 may be capable of gathering comprehensive data about its environment and state, enabling it to navigate effectively, make informed decisions, and adapt to changing conditions across a wide range of terrains and environmental situations.

In some cases, the autonomous ground vehicle 110 may autonomously execute a task, causing it to navigate through the environment using the sensors 170 and the motor 160. The execution of the first task may be based on the instructions received from the agent 120 and the data collected by the sensors 170.

The components of the autonomous ground vehicle 110 are interconnected, allowing for data flow and control signals to be exchanged between them. This interconnection enables the autonomous ground vehicle 110 to process information, make decisions, and execute actions, and interact with its environment.

In addition to the components described above, the autonomous ground vehicle 110 may include other conventional components that allow the vehicle to move. These components may include wheels, which provide a means of locomotion for the vehicle on various surfaces. In some cases, the autonomous ground vehicle 110 may utilize continuous tracks or tracked treads instead of or in addition to wheels. Continuous tracks may provide enhanced traction and stability in certain environments, such as rough terrain or loose soil. The specific configuration of these movement components may vary depending on the intended use and operating environment of the autonomous ground vehicle 110. The motor 160 may be connected to these movement components to drive the vehicle's motion, with the exact mechanism of power transfer potentially varying based on the specific design of the autonomous ground vehicle 110.

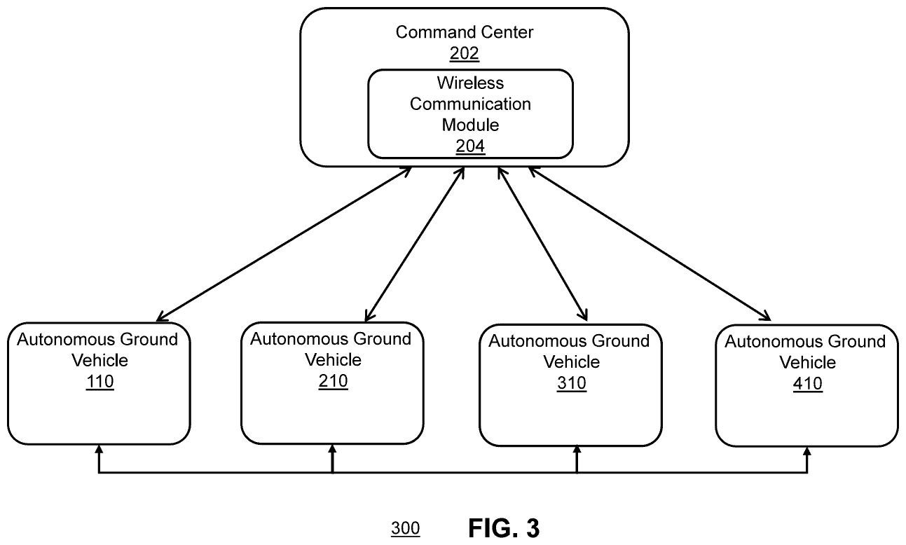

Referring to FIG. 3, a system diagram 300 of an autonomous ground vehicle network is illustrated. The system comprises a command center 202, which includes a wireless communication module 204. The command center 202 may be wirelessly connected to multiple autonomous ground vehicles that form a multi-agent swarm of autonomous ground vehicles. For example, in the exemplary system shown in FIG. 3, there are four autonomous ground vehicles including autonomous ground vehicle 110, second autonomous ground vehicle 210, third autonomous ground vehicle 310, and fourth autonomous ground vehicle 410.

The number of autonomous ground vehicles in the multi-agent swarm may vary. While four autonomous ground vehicles are shown in the exemplary system of FIG. 3, this number is used for illustrative purposes only. In practice, the multi-agent swarm may comprise any number of autonomous ground vehicles that is two or larger. The specific number of vehicles in the swarm may be determined based on factors such as the complexity of the mission, the size of the operational area, the available resources, and the desired level of redundancy. In some cases, the swarm may include tens, hundreds, or even thousands of autonomous ground vehicles working together to accomplish complex tasks. The scalability of the system allows for flexibility in deployment, enabling the swarm to be tailored to the specific requirements of each mission or application.

In some aspects, the autonomous ground vehicles within the multi-agent swarm may have different capabilities from one another, allowing them to perform a diverse range of tasks. This heterogeneity in capabilities may enhance the overall versatility and effectiveness of the swarm in various mission scenarios.

For example, some vehicles in the swarm may be equipped with specialized payloads tailored to specific functions. In some cases, certain autonomous ground vehicles may have explosive capabilities, allowing them to perform controlled detonations for tasks such as obstacle clearance or demolition, anti-personnel attacks, or anti-infrastructure attacks. Other vehicles may be outfitted with advanced camera systems, some of which may include extendable masts to provide elevated vantage points for surveillance or reconnaissance missions.

In some implementations, specific autonomous ground vehicles may be configured as medical support units, carrying medical kits and supplies for emergency response or humanitarian missions. These vehicles may be equipped with specialized sensors and tools to assess and respond to medical situations in the field.

Some vehicles in the swarm may be designed for logistical support, such as food rationing. These units may carry food supplies and be equipped with systems for storing, preserving, and distributing rations to support extended operations or humanitarian efforts.

The diverse capabilities of the autonomous ground vehicles may allow the swarm to adapt to a wide range of mission requirements. For instance, in a search and rescue operation, vehicles with advanced cameras and extendable masts may be used for wide-area surveillance, while medical support units could be deployed to provide immediate assistance to any individuals found. Simultaneously, vehicles with explosive capabilities might clear obstacles to create access routes, and food rationing units could sustain the operation over an extended period.

In some cases, the heterogeneous nature of the swarm may influence task allocation and coordination strategies. The system may consider the unique capabilities of each vehicle when assigning tasks, ensuring that specialized functions are matched with the most suitable units. This approach may optimize the use of resources within the swarm and enhance its overall effectiveness in complex, multi-faceted missions.

The wireless communication module 204 within the command center 202 facilitates bidirectional communication between the command center and each of the autonomous ground vehicles. This allows for the transmission of commands, behavior requests, and other data from the command center 202 to the vehicles, as well as the reception of status updates, sensor data, and other information from the vehicles back to the command center.

In some aspects, the wireless communication module 204 may utilize various types of wireless communication technologies to enable effective and reliable communication within the autonomous ground vehicle network. The wireless communication module 204 may utilize various types of wireless communication technologies, including cellular networks, Wi-Fi, Bluetooth, satellite communication, radio frequency (RF) communication, mesh network topology, low-power protocols like Zigbee, and ultra-wideband (UWB) technology, to enable effective and reliable communication within the autonomous ground vehicle network. The specific combination of wireless communication technologies used in the module may depend on factors such as the operational environment, mission requirements, and the capabilities of the autonomous ground vehicles. In some implementations, the wireless communication module may be designed to switch between different communication methods dynamically, selecting the most appropriate technology based on current conditions and requirements.

In some aspects, the command center 202 may take the form of a user input device remote from the multi-agent swarm of autonomous ground vehicles. This remote device may allow a user to send multi-agent behavior requests and other commands to the swarm. The user input device may be a mobile device, tablet, laptop, desktop computer, or specialized control unit equipped with the necessary software and communication capabilities to interact with the autonomous ground vehicle network. In some cases, the remote device may include a graphical user interface that allows the user to visualize the positions and status of the autonomous ground vehicles in real-time, as well as input commands or behavior requests through intuitive controls. The wireless communication module 204 of the command center 202 may facilitate secure and reliable communication between the remote user input device and the autonomous ground vehicles, ensuring that commands are transmitted accurately and executed promptly by the swarm.

In some aspects, the command center 202 may be implemented as a software application running on a computing device. This application may provide a user interface for monitoring and controlling the multi-agent swarm of autonomous ground vehicles. The application may be installed on various types of devices, such as smartphones, tablets, laptops, or desktop computers, allowing for flexible deployment and access to the command center functionality. The command center application may include features for visualizing the positions and status of the autonomous ground vehicles in real-time, planning missions, issuing multi-agent behavior requests, and analyzing data received from the vehicles. In some cases, the application may incorporate advanced algorithms for optimizing swarm behavior and adapting to changing mission parameters. The command center application may also support different levels of user access and control, allowing for hierarchical command structures where multiple users can interact with the swarm at various levels of authority. This may enable collaborative mission planning and execution across distributed teams.

In some aspects, the command center 202 receives a multi-agent behavior request from a user input executed on a device remote from the multi-agent swarm of autonomous ground vehicles. The multi-agent behavior request may then be transmitted to each of the autonomous ground vehicles via the wireless communication module 204. Upon receiving the multi-agent behavior request, each agent in the multi-agent swarm of autonomous ground vehicles may perform the translation of the multi-agent behavior request into tasks. This translation process may be performed by each agent in the multi-agent swarm, and each agent may obtain the same result of translating the multi-agent behavior request into one or more tasks.

In some aspects, the command center 202 may also receive status updates, sensor data, and other information from the autonomous ground vehicles. This information may be used to monitor the status and progress of the autonomous ground vehicles as they execute the tasks derived from the multi-agent behavior request. The command center 202 may also use this information to adjust the tasks or issue new behavior requests as needed.

In some aspects, the command center 202 may also include a processor and a memory for storing data and instructions for coordinating the multi-agent swarm of autonomous ground vehicles. The processor may execute instructions stored in the memory to control the operation of the command center 202, including the transmission and reception of data via the wireless communication module 204.

In some aspects, the command center 202 may allow a user to select from a predefined list of behavior requests. This list may include swarm behaviors such as line formation, converge, surround, defend, return to base, convoy travel, waypoint navigation, optimal area coverage, resilient network behavior with backtracking, route replay, mobile minefield, and multi-agent SLAM. The user interface of the command center 202 may present these options in a menu or dropdown list, allowing the user to quickly select and initiate desired swarm behaviors.

The command center 202 may also provide a more flexible interface for inputting custom behavior requests. In some cases, the command center 202 may utilize natural language processing (NLP) or other machine learning techniques to interpret and process user-defined behavior requests. This capability may allow users to input behavior requests using natural language descriptions, which the system then translates into executable commands for the autonomous ground vehicles. The NLP system may be trained on a diverse set of behavior descriptions and corresponding swarm actions, enabling it to understand and interpret a wide range of user inputs. For example, a user might input a request like “Form a perimeter around the target area” or “Spread out to cover maximum ground,” and the NLP system could interpret these requests and generate appropriate behavior commands for the swarm.

In some implementations, the command center 202 may employ machine learning algorithms to continuously improve its understanding and interpretation of user requests. The system may learn from user feedback and successful mission outcomes to refine its ability to translate natural language inputs into effective swarm behaviors. The command center 202 may also incorporate a hybrid approach, combining predefined behavior options with NLP-enabled custom inputs. This may provide users with the flexibility to quickly select common behaviors while also allowing for more complex or situation-specific requests when needed.

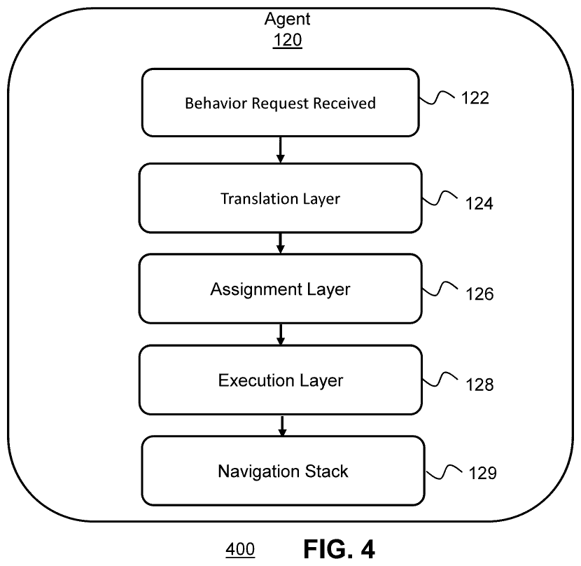

Referring to FIG. 4, a flowchart depicting a method 400 for processing a behavior request within an agent 120 of an autonomous ground vehicle is illustrated. The method 400 begins with a behavior request received 122, which initiates the process.

Following the receipt of the behavior request, the method 400 proceeds to a translation layer 124. The translation layer 124 is responsible for interpreting the received behavior request and converting it into a format that can be processed by subsequent layers.

In some aspects, the translation layer 124 may translate the behavior request into one or more tasks, each of the tasks being configured to be performed by a single agent within the multi-agent swarm of autonomous ground vehicles. In some aspects, the tasks generated by the translation layer 124 may represent specific goals or destinations for the autonomous ground vehicles. These tasks may include waypoints, target locations, or areas of interest that the vehicles need to reach or interact with. For example, a task may involve navigating to a particular set of coordinates, exploring a designated area, or positioning the vehicle in relation to other vehicles or objects in the environment.

The tasks may also encompass more complex objectives that require the vehicle to perform specific actions at certain locations. For instance, a task might involve reaching a designated point and then conducting a sensor sweep of the surrounding area, or moving to a series of locations in a particular sequence to create a desired formation.

In some cases, the tasks may be dynamic, with goals or destinations that change based on real-time information or evolving mission parameters. This flexibility allows the autonomous ground vehicles to adapt their behavior and movement patterns in response to new data or changing environmental conditions.

The translation layer 124 may break down high-level behavior requests into these location-based or goal-oriented tasks, providing clear objectives for each autonomous ground vehicle to pursue. This approach allows for efficient coordination of the multi-agent swarm, as each vehicle can focus on achieving its assigned goals or reaching its designated locations while contributing to the overall mission objectives.

In some aspects, the system may receive a request using GPS coordinates and then generate a map frame with three dimensional points (e.g., x, y, z) for the autonomous ground vehicles. This approach may allow for easier navigation and coordination in a three dimensional Cartesian space compared to using GPS coordinates directly. The system may establish a fixed three dimensional space or implement a moving frame, depending on the specific requirements of the mission or environment. In some cases, the system may set up a stationary frame by designating a specific GPS coordinate as the origin point. From this origin, the system may derive x, y, and z coordinates for the autonomous ground vehicles and other points of interest within the operational area. This translation from GPS coordinates to a three dimensional Cartesian space may simplify path planning, formation control, and other spatial calculations for the multi-agent swarm. The system may update the map frame periodically or in real-time to account for changes in the environment or the positions of the autonomous ground vehicles.

In some aspects, the system may be further configured to translate the multi-agent behavior request by selecting a translation algorithm from a plurality of translation algorithms based on the multi-agent behavior request. The selection of the translation algorithm may depend on various factors such as the type of behavior requested, the complexity of the task, the number of autonomous ground vehicles involved, and the current environmental conditions.

The system may maintain a library of translation algorithms, each optimized for different types of multi-agent behavior requests. For example, there may be specific algorithms for translating line formation requests, surround behavior requests, converge behavior requests, and other swarm behaviors. Additionally, there may be more general-purpose algorithms capable of handling a wide range of behavior requests. Once a suitable translation algorithm is selected, the system may apply the selected translation algorithm to generate the one or more tasks. This process may involve breaking down the high-level behavior request into specific, actionable tasks that individual autonomous ground vehicles can perform. The tasks generated may vary in complexity and specificity depending on the nature of the behavior request and the capabilities of the autonomous ground vehicles in the swarm.

In some cases, the system may employ machine learning techniques to improve the selection and application of translation algorithms over time. The system may learn from past experiences, adjusting its algorithm selection criteria based on the success rates of previous translations and task executions. This adaptive approach may allow the system to become more efficient and effective in translating multi-agent behavior requests into executable tasks as it gains more operational experience. The system may also consider the current state of the autonomous ground vehicles, including their positions, capabilities, and available resources, when applying the selected translation algorithm. This context-aware translation process may help ensure that the generated tasks are feasible and optimized for the current state of the swarm.

The translation layer 124 may also translate the multi-agent behavior request into one or more constraints. The constraints may include, for example, a keep-out zone, a minimum distance between two or more autonomous ground vehicles of the multi-agent swarm of autonomous ground vehicles, or a maximum distance between two or more autonomous ground vehicles of the multi-agent swarm of autonomous ground vehicles.

In some aspects, the system may be configured to translate the multi-agent behavior request by selecting a translation algorithm from a plurality of translation algorithms based on the multi-agent behavior request, and applying the selected translation algorithm to generate the one or more constraints. This approach may allow for a flexible and adaptive constraint generation process that can accommodate various types of behavior requests and operational scenarios.

The system may maintain a library of constraint translation algorithms, each designed to generate constraints suitable for different types of multi-agent behaviors or environmental conditions. For example, there may be specific algorithms for generating constraints related to formation maintenance, obstacle avoidance, or communication range limitations. The selection of the appropriate constraint translation algorithm may depend on factors such as the nature of the behavior request, the current operational environment, and the capabilities of the autonomous ground vehicles in the swarm.

Once a suitable constraint translation algorithm is selected, the system may apply it to generate one or more constraints that help guide the execution of the multi-agent behavior. These constraints may define, for example, operational boundaries, safety parameters, or performance requirements for the autonomous ground vehicles. For instance, when translating a line formation behavior request, the selected algorithm may generate constraints related to inter-vehicle spacing and alignment. For a surround behavior request, the algorithm may produce constraints that define the perimeter around the target and specify minimum and/or maximum distances between vehicles. In some cases, the constraint translation process may take into account real-time data from the autonomous ground vehicles and the environment. This may allow the system to generate dynamic constraints that adapt to changing conditions during mission execution. For example, if the system detects obstacles or restricted areas in the operational environment, it may adjust the constraint translation process to incorporate these factors into the generated constraints.

The system may also employ machine learning techniques to refine and optimize the constraint translation process over time. By analyzing the effectiveness of generated constraints in various scenarios, the system may learn to select and apply constraint translation algorithms more efficiently. This adaptive approach may enable the system to generate increasingly sophisticated and context-appropriate constraints as it gains operational experience.

In some aspects, the constraints generated during the translation of the multi-agent behavior request may play a role in guiding the actions of the autonomous ground vehicles. These constraints may be designed to ensure safe and efficient operation of the multi-agent swarm while accomplishing the desired behavior.

One type of constraint that may be implemented is a keep-out zone. This constraint may define areas that the autonomous ground vehicles should avoid during their operations. Keep-out zones may be used to prevent the vehicles from entering dangerous or restricted areas, or to ensure that the vehicles do not interfere with other operations or entities in the environment.

In some cases, the constraints may include minimum and/or maximum distance requirements between two or more autonomous ground vehicles in the multi-agent swarm. These distance constraints may help maintain proper spacing between vehicles, which can be important for safety, communication efficiency, and optimal formation maintenance. The minimum distance constraint may prevent collisions between vehicles, while the maximum distance constraint may ensure that the vehicles remain within effective communication range of each other.

In some aspects, the constraints may include move-through zones, which define specific regions or areas that all vehicles in the swarm are required to traverse. These move-through zones may be implemented to ensure that the autonomous ground vehicles cover particular areas of interest or follow specific paths during their operations. The move-through zones may be defined by geographical coordinates, landmarks, or other reference points that the autonomous ground vehicles can recognize and navigate towards. The implementation of move-through zones may involve additional path planning considerations for the autonomous ground vehicles. Each vehicle may need to incorporate these zones into their navigation algorithms, potentially adjusting their routes to ensure passage through the designated areas while still maintaining formation and adhering to other constraints. In some cases, the order or timing of vehicles moving through these zones may be coordinated to optimize the overall swarm behavior and mission objectives. Move-through zones may be particularly useful in scenarios where comprehensive coverage of an area is required, such as in search and rescue operations, environmental monitoring, or surveillance missions. They may also be employed to guide the swarm through specific corridors or pathways, which may be beneficial in urban environments or areas with complex terrain. In some implementations, the move-through zones may be dynamic, changing based on real-time data or evolving mission requirements. This flexibility may allow the swarm to adapt to new information or changing conditions in the environment, ensuring that the autonomous ground vehicles continue to operate effectively and efficiently throughout their mission.

The constraints may also include speed limits or acceleration restrictions. These may be implemented to ensure smooth and coordinated movement of the swarm, particularly during complex maneuvers or in challenging environments. Speed constraints may also be adjusted dynamically based on factors such as terrain conditions, visibility, or the presence of obstacles.

In some implementations, the constraints may include orientation requirements for individual vehicles or for the swarm as a whole. These orientation constraints may be particularly relevant in behaviors such as line formation or surround behaviors, where the positioning and facing of each vehicle may be important to the overall effectiveness of the swarm.

The system may also implement temporal constraints, which may specify time limits for completing certain tasks or reaching specific waypoints. These temporal constraints may help ensure that the swarm operates efficiently and meets mission objectives within required timeframes.

In some aspects, the constraints may include communication-related restrictions. These may specify requirements for maintaining communication links between vehicles, such as minimum signal strength or maximum allowable latency. Such constraints may be beneficial for ensuring effective coordination and information sharing within the swarm.

Environmental constraints may also be generated based on the behavior request and the current operating conditions. These may include restrictions related to weather conditions, terrain types, or time of day, which may affect the capabilities and behavior of the autonomous ground vehicles.

In some cases, the constraints may be hierarchical or prioritized. This may allow the system to handle situations where multiple constraints conflict, by providing a clear order of precedence. For example, safety-related constraints may take priority over efficiency-related constraints in certain scenarios.

The system may also implement adaptive constraints that can be modified in real-time based on changing conditions or new information. This adaptability may allow the swarm to respond more effectively to dynamic environments and unforeseen circumstances while still adhering to the overall behavior objectives.

After the translation layer 124, the method 400 moves to an assignment layer 126. The assignment layer 126 is where tasks derived from the translated behavior request are allocated to the agent 120 or other agents in a multi-agent system.

In the assignment layer 126, the system may assign the tasks based, at least in part, on a cost function. This cost function may indicate that a given task is configured to be performed by one agent more efficiently than by another agent in the multi-agent swarm of autonomous ground vehicles. The cost function may take into account various factors to determine the efficiency of task execution by different agents. These factors may include the current position of each agent, their available resources, capabilities, and current workload. In some cases, the cost function may also consider the estimated time and energy consumption required for each agent to complete the task.

The system may evaluate the cost function for each task and each agent in the swarm. This evaluation process may involve calculating a score or value that represents the efficiency with which each agent can perform each task. The agent with the most favorable score for a particular task may then be assigned that task. In some implementations, the assignment process may be dynamic and adaptive. The system may continuously update the cost function calculations as the environment changes or as agents complete their assigned tasks or become inoperable. This ongoing evaluation may allow for real-time task reassignment if conditions change or if a more efficient allocation becomes possible.

The assignment layer may also consider task dependencies and priorities when allocating tasks. Some tasks may need to be completed in a specific order or may have prerequisites. The system may take these factors into account to ensure that the overall mission objectives are met efficiently.

In some cases, the assignment layer may employ optimization algorithms to find the most efficient overall allocation of tasks across the entire swarm. This may involve considering not just individual task-agent pairings, but the collective efficiency of the entire task distribution.

The system may also incorporate learning mechanisms in the assignment layer. Over time, it may learn which types of tasks are most efficiently performed by which agents under various conditions. This learned knowledge may be used to refine and improve the cost function and task assignment process in future operations.

In some aspects, the assignment layer 126 may implement a consensus-based bundling algorithm to allocate tasks among the agents in the multi-agent swarm of autonomous ground vehicles. This algorithm may provide a distributed approach to task assignment, allowing each agent to participate in the decision-making process.

The consensus-based bundling algorithm may begin with each agent in the multi-agent swarm making a bid on each task. These bids may be based on various factors including those discussed above, such as the agent's current position, available resources, capabilities, and estimated time or energy required to complete the task. The bidding process may allow agents to express their suitability for specific tasks based on their individual characteristics and current state.

In some aspects, the score calculated for each task may be used as a key component in the bidding process within the consensus-based bundling algorithm. This score may represent a quantitative measure of an agent's suitability and efficiency for performing a specific task. When making a bid, each agent may use its calculated score as at least part of the basis for determining the value of its bid.

In some aspects, the capabilities of individual autonomous ground vehicles may influence their bidding process for specific tasks. For example, in a scenario where the multi-agent swarm receives a task to conduct aerial surveillance of a particular area, an autonomous ground vehicle equipped with a high-resolution camera mounted on an extendable mast may submit a competitive bid for this task, as it has the capability to capture elevated images of the surrounding area. In contrast, a vehicle without such imaging equipment may submit a bid of zero for this task, effectively removing itself from consideration.

Similarly, in a task requiring underwater exploration, an amphibious autonomous ground vehicle may submit a high bid due to its ability to navigate both on land and in water. Other vehicles in the swarm without amphibious capabilities may bid zero for this task, acknowledging their inability to perform the required underwater operations.

In some cases, the bidding process may also consider the quality or efficiency with which a task can be performed. For instance, if a task involves traversing rough terrain, a vehicle with advanced suspension and all-terrain tires may submit a higher bid than a vehicle designed primarily for paved surfaces, even if both are technically capable of completing the task. The vehicle with superior off-road capabilities may be able to complete the task more quickly or with less risk of damage, factors which may be reflected in its higher bid.

The system may also consider more nuanced capabilities when evaluating bids. For example, if a task requires long-range operations, vehicles with larger fuel capacities or more efficient power systems may submit higher bids, reflecting their ability to operate for extended periods without refueling or recharging. Conversely, vehicles with limited range may submit lower bids or even zero bids for such tasks, recognizing their limitations in meeting the task requirements.

In some aspects, agents in the multi-agent swarm may consider their existing task bundle when bidding on additional tasks. This approach may allow for more efficient task allocation and execution by taking into account the potential synergies or conflicts between new tasks and those already assigned to an agent.

When an agent evaluates a new task for bidding, it may analyze how the addition of this task would affect its current bundle of tasks. The agent may consider various factors in this analysis. Spatial proximity may be taken into account, as the agent may submit a higher bid if the new task is located near its current or planned positions for existing tasks, potentially allowing completion with minimal additional travel. Temporal alignment may also be evaluated, with the agent potentially bidding more aggressively if the new task can be efficiently interleaved with current tasks. The agent may assess resource utilization, considering how the new task would impact the use of its resources such as battery life, fuel, or specialized equipment. If the new task allows for more efficient use of resources already allocated for existing tasks, the agent may increase its bid. Capability overlap may be another factor, with the agent potentially submitting a higher bid if the new task requires capabilities similar to those needed for its current tasks, as it may already be configured or positioned to perform the task effectively. Workload balance may be considered, with agents potentially bidding more aggressively on new tasks if they have a lighter current task bundle, aiming to balance the workload across the swarm. Task dependencies may influence bidding, with the agent potentially adjusting its bid if the new task has dependencies or relationships with tasks already in its bundle. For example, if completing the new task would provide information or resources that benefit the execution of existing tasks, the agent may increase its bid. Finally, agents may evaluate how the addition of a new task to their bundle would contribute to overall mission objectives, potentially bidding more competitively if the combination of the new task with existing tasks aligns well with mission goals.

In some implementations, agents may use predictive models or simulations to estimate the impact of adding a new task to their current bundle. These models may help agents calculate more accurate bids by considering complex interactions between tasks and projecting the overall efficiency of their updated task bundle.

The system may also allow for task bundle optimization during the bidding process. An agent may consider not only adding the new task to its current bundle but also potentially releasing or swapping existing tasks if doing so would result in a more efficient overall allocation for the swarm.

By considering their current task bundles when bidding on new tasks, agents may contribute to a more holistic and efficient task allocation process for the entire swarm. This approach may lead to improved resource utilization, reduced conflicts between tasks, and enhanced overall performance in achieving the swarm's objectives.

In some aspects, the bidding process may incorporate a time-decayed reward function, where the potential reward for completing a task diminishes as time progresses. This approach may encourage agents to prioritize tasks that can be completed more quickly or efficiently, promoting overall swarm responsiveness and task completion rates.

For example, when evaluating tasks for bidding, agents may consider not only the immediate value of completing a task but also how that value may decrease over time. The time-decayed reward function may be implemented in various ways, depending on the specific requirements of the mission and the nature of the tasks involved.

For example, the reward for a task may decrease linearly over time, with a fixed reduction in value for each unit of time that passes. Alternatively, the decay may follow an exponential curve, where the rate of value loss accelerates as more time elapses. The specific parameters of the decay function may be adjusted based on the urgency of the task, its importance to the overall mission, or other relevant factors.

In some implementations, the time-decayed reward may be calculated from the moment the task is introduced to the swarm, encouraging quick response and efficient allocation. In other cases, the decay may begin from the time an agent commits to a task, incentivizing prompt execution once a task is assigned.

The use of a time-decayed reward function may influence how agents prioritize and bid on tasks. Agents may be more likely to bid aggressively on tasks they can complete quickly, as the potential reward for these tasks will remain higher. Conversely, agents may be less inclined to bid on tasks that would take them a long time to reach or complete, as the reward for these tasks may have significantly diminished by the time they are finished. This approach may help balance the workload across the swarm by discouraging individual agents from taking on too many tasks or tasks that are too far away. It may also promote a more dynamic and responsive swarm behavior, as agents continually reassess the value of available tasks in light of the decreasing rewards over time.

In some cases, the time-decayed reward function may be combined with other factors in the bidding process, such as the agent's capabilities, current location, and existing task bundle. This multi-faceted approach to task valuation may allow for a more nuanced and efficient allocation of tasks across the swarm.

The system may also adapt the parameters of the time-decay function based on the overall performance of the swarm and the changing priorities of the mission. For instance, if certain types of tasks are consistently being completed too slowly, the system may increase the rate of reward decay for these tasks to encourage faster allocation and execution.

In some aspects, the system may be configured to handle the introduction of new high-priority tasks dynamically. When a new task is designated as having a higher priority than existing tasks, the system may assign it a higher initial reward value in the bidding process. This approach may allow the system to quickly allocate resources to urgent or critical tasks as they arise.

The higher initial reward for high-priority tasks may be implemented within the time-decayed reward function used in the bidding process. For instance, the system may apply a priority multiplier to the base reward value of the task. This multiplier may be proportional to the task's priority level, resulting in a higher starting point for the reward decay curve of high-priority tasks.

In some cases, the introduction of a high-priority task may trigger a re-evaluation of the entire task allocation across the swarm. The system may initiate a new round of bidding, allowing agents to reassess their bids based on the new task's priority and their current capabilities and task loads. This dynamic reallocation may help ensure that the most critical tasks are addressed promptly by the most suitable agents in the swarm.

In some implementations, the system may use machine learning algorithms to adaptively adjust the initial reward values for tasks of varying priorities. By analyzing historical data on task execution and swarm performance, the system may refine its approach to setting initial rewards, optimizing the balance between task priority and overall swarm efficiency.

Once the bids are made, the algorithm may facilitate communication of these bids between each agent in the swarm. This communication process may involve agents sharing their bid information with neighboring agents or broadcasting their bids to the entire swarm. The exchange of bid information may enable each agent to build a comprehensive view of the swarm's collective capabilities and preferences for task allocation.

In some aspects, the bids may be communicated between agents in the multi-agent swarm using various methods and protocols, including those already discussed herein. For example, the system may employ a mesh network topology, where each autonomous ground vehicle acts as a node capable of relaying information to its neighbors. This approach may allow for robust and decentralized communication, even in environments with limited infrastructure or challenging terrain.

The system may utilize different communication protocols depending on the operational context. In some cases, short-range, high-bandwidth technologies such as Wi-Fi or Bluetooth may be used for close-proximity communication between agents. For longer-range communication, the system may employ cellular networks or satellite communication systems, enabling coordination across larger geographical areas. In some implementations, the system may use a hybrid communication approach, combining multiple technologies to ensure reliable data exchange.

In some aspects, the autonomous ground vehicles in the multi-agent swarm may communicate with each other and the command center using periodic status messages, such as heartbeat messages. These messages may be transmitted at regular intervals to indicate that a vehicle is operational and capable of performing its assigned tasks. The heartbeat messages may include information about the vehicle's current status, position, task progress, and available resources.

If a given vehicle stops sending heartbeat messages, the system may infer that the vehicle is no longer able to complete its tasks. This interruption in communication may be due to various factors, such as mechanical failures, communication system malfunctions, or unexpected environmental obstacles. In such cases, the system may initiate a task reassignment process to ensure the continuity of the mission.

When a vehicle's heartbeat messages are not received for a predetermined period, the system may automatically flag that vehicle as potentially non-operational. In some implementations, the system may employ predictive algorithms to anticipate potential communication failures or vehicle malfunctions based on patterns in the heartbeat messages or other telemetry data. This proactive approach may allow the system to begin preparing for task reassignment before a vehicle completely stops communicating, potentially reducing the impact on overall mission performance.

The heartbeat message system may also be used to dynamically adjust the swarm's behavior. For example, if multiple vehicles in a particular area stop sending heartbeat messages, the system may infer the presence of a communication dead zone or a hazardous area. This information may be used to update the swarm's environmental map and adjust task assignments or navigation routes accordingly.

By implementing a robust communication system with heartbeat messages and adaptive task reassignment capabilities, the multi-agent swarm may maintain operational efficiency and mission continuity even in the face of individual vehicle failures or communication disruptions.

After the communication phase, the algorithm may proceed to resolve conflicts in task assignment. Conflict resolution may involve comparing bids from different agents for the same task and determining which agent is best suited to perform the task. This process may take into account not only the individual bids but also the overall efficiency of the swarm and the interdependencies between tasks.

In some implementations, the conflict resolution process may involve iterative negotiations between agents. Agents may adjust their bids based on the information received from other agents, potentially leading to a more optimal task allocation. The algorithm may also consider task bundling, where multiple related tasks are assigned to a single agent to improve overall efficiency.

The consensus-based bundling algorithm may continue the process of bidding, communication, and conflict resolution until a consensus is reached on task assignments. This consensus may represent a task allocation that balances individual agent capabilities with the overall goals of the swarm.

In some cases, the algorithm may incorporate adaptive mechanisms to handle dynamic environments or changing task requirements. For example, if new tasks are introduced or existing tasks are modified during operation, the algorithm may initiate a new round of bidding and negotiation to reassign tasks as needed.

The implementation of a consensus-based bundling algorithm in the assignment layer 126 may offer several potential advantages. It may promote a more flexible and robust task allocation process, as decisions are made collectively by the swarm rather than by a centralized authority. This distributed approach may also enhance the scalability of the system, allowing it to handle larger numbers of agents and tasks efficiently.

In some aspects, the system may allow a user or command center to withdraw or modify tasks that have been assigned to the autonomous ground vehicles in the multi-agent swarm. This capability may provide flexibility in responding to changing mission requirements, environmental conditions, or strategic priorities. The system may incorporate mechanisms for the user or command center to review current task assignments, select specific tasks for withdrawal or modification, and initiate the process of task reallocation. When a task is withdrawn or modified, the system may trigger a new round of bidding among the autonomous ground vehicles, allowing for efficient redistribution of resources and responsibilities within the swarm. This dynamic task management feature may enhance the adaptability and responsiveness of the multi-agent swarm to evolving operational needs.

In some aspects, the translation of the multi-agent behavior request into tasks and constraints may be performed locally at each autonomous ground vehicle. This decentralized approach may allow each vehicle to independently interpret and process the behavior request, potentially reducing communication overhead and enhancing system resilience. Local translation may enable faster response times, as each vehicle can immediately begin processing the request without waiting for instructions from a central authority.

Alternatively, the translation process may be performed at a remote location, such as a command center or a dedicated processing node. In some implementations, the system may dynamically switch between local and remote translation based on factors such as the complexity of the behavior request, available computational resources, and current communication conditions.

In some aspects, when the translation of the multi-agent behavior request into tasks and constraints is performed locally at each autonomous ground vehicle, each vehicle may obtain the same result from the translation process. This consistency in translation outcomes may be achieved through the use of standardized translation algorithms and protocols implemented across all vehicles in the swarm. By ensuring that each vehicle interprets and processes the behavior request in the same manner, the system may maintain coherence in task generation and constraint definition across the entire swarm.

The uniformity in translation results may be facilitated by several factors. Each autonomous ground vehicle may be equipped with identical software modules for request translation, ensuring that the same logic and procedures are applied regardless of which vehicle performs the translation. Additionally, the vehicles may utilize a common set of predefined rules or guidelines for interpreting various types of behavior requests, further promoting consistency in the translation process.

The consistency in translation results across all vehicles may contribute to improved coordination and efficiency within the swarm. It may reduce the likelihood of conflicting interpretations of the behavior request, which could otherwise lead to uncoordinated or contradictory actions among the vehicles. Furthermore, this approach may enhance the robustness of the system, as any vehicle in the swarm may be capable of performing the translation with the assurance that its results will align with those of its peers.

The next step in the method 400 is the execution layer 128. In this layer, the assigned tasks are carried out by the agent 120. The execution layer 128 is responsible for implementing the actions necessary to fulfill the behavior request. In some aspects, the execution layer 128 may autonomously execute the assigned tasks while adhering to the one or more constraints. The execution of the assigned tasks may cause the autonomous ground vehicle to navigate through an environment using the one or more sensors, the motor of the vehicle, and other components that allow the vehicle to move.

In some aspects, the execution layer 128 may manage a navigation stack 129 to facilitate the autonomous execution of tasks by the agent 120. The navigation stack 129 may comprise a set of software modules and algorithms that work together to plan and execute the movement of the autonomous ground vehicle through its environment. When a task is passed to the execution layer 128, it may query the navigation stack 129 to determine the optimal path for completing the task. The navigation stack 129 may take into account various factors such as the current position of the vehicle, known obstacles in the environment, and any constraints associated with the task. In some implementations, the navigation stack 129 may continuously update its plans based on real-time sensor data from the autonomous ground vehicle. This adaptive approach may allow the vehicle to respond to dynamic changes in its environment, such as moving obstacles or newly discovered terrain features.

The execution layer 128 may also use the navigation stack 129 to manage the vehicle's speed and orientation during task execution. By interfacing with the motor control systems, the navigation stack may help ensure smooth and efficient movement of the autonomous ground vehicle as it carries out its assigned tasks.

In some cases, the navigation stack 129 may incorporate machine learning algorithms to improve its performance over time. By analyzing data from successful task executions, the system may refine its path planning and obstacle avoidance strategies, potentially leading to more efficient navigation in future operations.

In some aspects, the execution layer 128 may ensure that tasks are performed in the correct order as required by the specific behavior request. In some aspects, the execution layer may maintain a prescribed order of task execution that aligns with the logical sequence necessary for the requested behavior. For example, in a scenario where both a surround behavior and a converge behavior are requested, the execution layer may enforce the requirement that the surround behavior is completed before initiating the converge behavior.

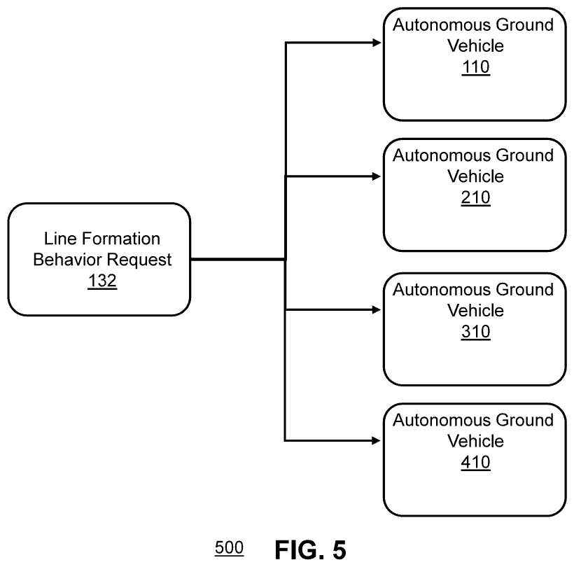

Referring to FIG. 5, a system diagram 500 of a multi-agent autonomous ground vehicle system executing a line formation behavior is illustrated. The system may comprise a line formation behavior request 132 and a plurality of autonomous ground vehicles that form a multi-agent swarm, such as the four autonomous ground vehicles described with respect to FIG. 3 including first autonomous ground vehicle 110, second autonomous ground vehicle 210, third autonomous ground vehicle 310, and fourth autonomous ground vehicle 410.

In some aspects, the line formation behavior request 132 may be one type of a multi-agent behavior request, which may also include, but not limited to, a surround behavior or a converge behavior. The line formation behavior request 132 may specify a desired formation for the autonomous ground vehicles, such as a straight line, a curved line, or any other suitable formation. The line formation behavior request 132 may also specify a desired orientation for the line formation, such as a north-south orientation, an east-west orientation, or any other suitable orientation.

In some aspects, the line formation behavior request 132 may be received by each of the autonomous ground vehicles via their respective wireless communication modules. Upon receiving the request, each vehicle may translate the request into specific tasks and constraints using their onboard processing capabilities. The translation process may involve determining, for example, the desired spacing between vehicles, the orientation of the line, and the order in which the vehicles should arrange themselves.

The autonomous ground vehicles may then use their sensors to assess their current positions relative to each other and the desired line formation. Based on this assessment, each vehicle may generate a set of navigation instructions to move into the correct position. These instructions may be continuously updated as the vehicles move, ensuring that they maintain the proper spacing and alignment throughout the maneuver.

In some aspects, the vehicles may communicate with each other during the execution of the line formation behavior. This communication may allow them to coordinate their movements more effectively, adjusting their speeds and trajectories as needed to achieve and maintain the desired formation. The vehicles may also share sensor data to enhance their collective awareness of the environment and any potential obstacles.

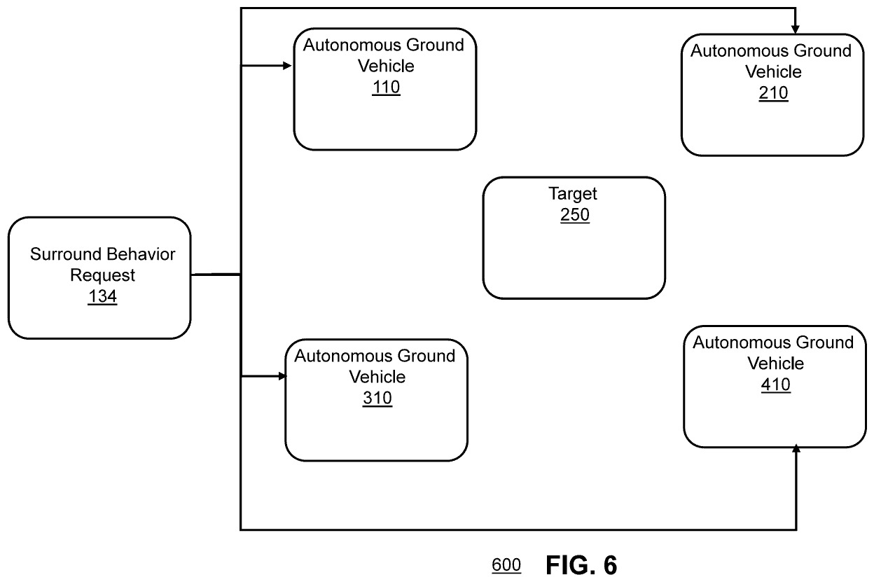

Referring to FIG. 6, a system diagram 600 of an autonomous ground vehicle swarm executing a surround behavior is illustrated. The system may comprise a surround behavior request 134 and a plurality of autonomous ground vehicles that form a multi-agent swarm, such as the four autonomous ground vehicles described with respect to FIG. 3 including first autonomous ground vehicle 110, second autonomous ground vehicle 210, third autonomous ground vehicle 310, and fourth autonomous ground vehicle 410. The surround behavior request 134 initiates the operation for each of the autonomous ground vehicles to surround or be arranged around a target 250.

Upon receiving the surround behavior request 134, each autonomous ground vehicle may translate the request into specific tasks and constraints. These may include, for example, determining the optimal positions around the target 250, calculating the required distance from the target, and establishing any specific orientation requirements.

In some aspects, the autonomous ground vehicles may use their sensors to locate and track the target 250. They may continuously update their positions relative to the target and each other, adjusting their movements to maintain the surrounding formation. The vehicles may also communicate with each other to coordinate their movements and ensure even spacing around the target.

The surround behavior may involve dynamic adjustment capabilities. For instance, if the target 250 is mobile, the autonomous ground vehicles may continuously update their positions to maintain the surrounding formation. Additionally, the vehicles may be programmed to respond to changes in the environment or additional commands, such as tightening or loosening the surrounding formation, or the loss of a vehicle while executing the behavior, such as loss of a vehicle from enemy fire.

In some aspects, the surround behavior request 134 may specify the desired shape of the formation around the target 250. For example, the request may instruct the autonomous ground vehicles to surround the target in a circular formation, creating an even perimeter around the target. Alternatively, the surround behavior request 134 may specify other geometric shapes, such as a square, triangle, or polygon, depending on the number of vehicles in the swarm and the specific requirements of the mission.

The surround behavior request 134 may also include parameters for the formation shape, such as the desired radius of a circular formation or the side length of a square formation. In some cases, the request may specify an asymmetrical formation, with some vehicles positioned closer to the target than others. This flexibility in formation shape may allow the swarm to adapt to various environmental conditions or mission objectives.

When executing the surround behavior, the autonomous ground vehicles may use their onboard processing capabilities to calculate their individual positions within the specified formation shape. The vehicles may continuously adjust their positions to maintain the desired shape, even if the target 250 is moving or if environmental obstacles require modifications to the formation.

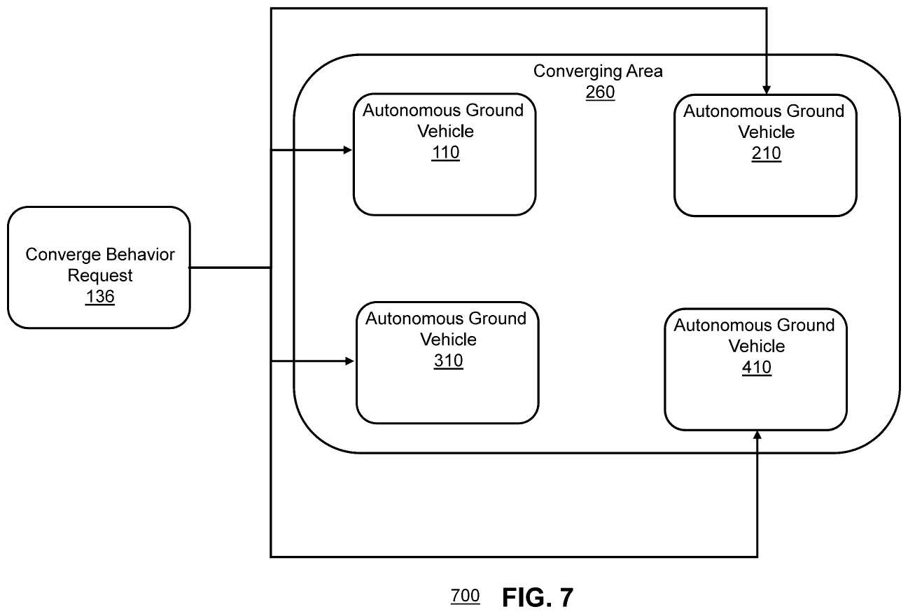

Referring to FIG. 7, a system diagram 700 of a multi-agent autonomous ground vehicle system executing a converge behavior is illustrated. The system may comprise a converge behavior request 136 and a plurality of autonomous ground vehicles that form a multi-agent swarm, such as the four autonomous ground vehicles described with respect to FIG. 3 including first autonomous ground vehicle 110, second autonomous ground vehicle 210, third autonomous ground vehicle 310, and fourth autonomous ground vehicle 410. The system receives a converge behavior request 136, which initiates the convergence operation to cause the swarm of autonomous ground vehicles to be positioned within a converging area 260.

In some cases, upon receiving the converge behavior request 136, each autonomous ground vehicle may translate the request into specific tasks and constraints. These may include, for example, identifying a convergence point within the converging area 260, determining the optimal path to reach that point, and establishing any speed or spacing requirements during the convergence process.

The autonomous ground vehicles may use their sensors and communication capabilities to coordinate their movements during the convergence. They may continuously update their positions relative to each other and the convergence point, adjusting their speeds and trajectories as needed to avoid collisions and ensure a smooth convergence.

In some aspects, the convergence behavior may involve prioritization or sequencing. For example, the autonomous ground vehicles may be programmed to converge in a specific order, or they may dynamically determine the order based on their current positions and the most efficient paths to the convergence point.

The converging area 260 may represent a physical or virtual boundary within which the convergence operation takes place. This area may be defined by geographical coordinates, landmarks, or other reference points that the autonomous ground vehicles can recognize and use for navigation.

In executing these behaviors (e.g., line formation, surround, and converge), the autonomous ground vehicles may utilize various navigation and control algorithms. These may include path planning algorithms to determine the most efficient routes, obstacle avoidance algorithms to navigate around any impediments, and formation control algorithms to maintain the desired spatial relationships between vehicles. The execution of these behaviors may also involve continuous monitoring and adjustment. The autonomous ground vehicles may use their sensors to detect changes in the environment or unexpected obstacles, and they may modify their actions accordingly. This adaptive capability allows the multi-agent swarm to respond flexibly to dynamic situations while still achieving the overall behavior objectives.

In addition to the line formation, surround, and converge behaviors described in FIGS. 4-6, the multi-agent swarm of autonomous ground vehicles may be capable of executing a wide variety of other formation requests and behaviors. The specific behaviors illustrated in FIGS. 4-6 are provided for exemplary purposes only and do not limit the scope of possible multi-agent behaviors that may be implemented.

In some aspects, the multi-agent swarm may execute more complex behaviors such as adaptive formations that change based on environmental conditions or mission objectives. For example, the swarm may transition between different formations as it moves through varied terrain or encounters obstacles. The system may also support task-specific formations tailored to particular mission requirements. These may include formations optimized for perimeter defense, area exploration, or coordinated object manipulation. In some implementations, the system may allow for user-defined custom formations, enabling operators to create new behavior requests tailored to specific operational needs.

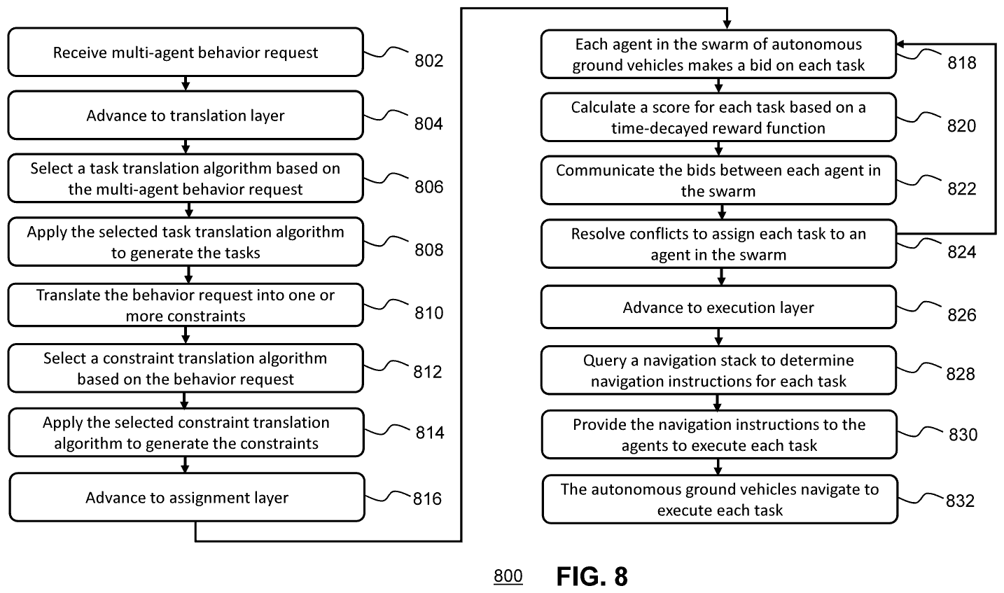

Referring to FIG. 8, a flowchart illustrating a method 800 for coordinating autonomous ground vehicles in a multi-agent swarm is shown. The method 800 may provide a systematic approach for processing multi-agent behavior requests and executing coordinated actions within a swarm of autonomous ground vehicles.

The method 800 may begin at step 802, where a multi-agent behavior request is received. This request may be transmitted from a command center or another authorized source and may specify a desired behavior for the swarm, such as a line formation, surround, or converge behavior.

In step 804, the multi-agent behavior request may be translated into one or more tasks at the translation layer. This translation process may involve breaking down the high-level behavior request into specific, actionable tasks that individual autonomous ground vehicles can perform. To facilitate this translation, step 806 may involve selecting a task translation algorithm based on the multi-agent behavior request. The selection of the algorithm may depend on the type of behavior requested and the current operational context of the swarm. In step 808, the selected task translation algorithm may be applied to generate the one or more tasks.

The method 800 may also translate the behavior request into one or more constraints in step 810. For example, this may be performed concurrently with the task generation. These constraints may help ensure safe and efficient operation of the swarm while accomplishing the desired behavior. To facilitate this translation, step 812 may involve selecting a constraint translation algorithm based on the behavior request. The selection of this algorithm may consider factors such as the type of behavior, environmental conditions, and safety requirements. In step 814, the selected constraint translation algorithm may be applied to generate the one or more constraints.

Once the tasks and constraints have been generated, the method 800 may proceed to the assignment layer at step 816, where each task is assigned based on a cost function. This assignment process may involve a bidding mechanism among the autonomous ground vehicles in the swarm. In step 818, each agent in the swarm of autonomous ground vehicles may make a bid on each task. The bidding process may take into account various factors, including the agent's current position, capabilities, and available resources. To make the bids, step 820 may involve calculating a score for each task based on, for example, a time-decayed reward function. This scoring mechanism may prioritize tasks that can be completed more quickly or efficiently. In step 822, the bids may be communicated between each agent in the swarm of autonomous ground vehicles, allowing for a distributed decision-making process. Step 824 may involve resolving any conflicts that arise during the bidding process to assign each task to an agent in the swarm of autonomous ground vehicles.

After task assignment, the method 800 may proceed to the execution layer at step 826. In this layer, each task may be autonomously executed while adhering to each constraint. This execution may involve complex navigation and coordination among the autonomous ground vehicles. To facilitate this, step 828 may involve querying a navigation stack to determine navigation instructions for completing each task. These instructions may take into account the current positions of the vehicles, environmental obstacles, and the constraints generated earlier in the process.

In step 830, the navigation instructions may be provided to the agents to execute each task. Finally, in step 832, the autonomous ground vehicles may navigate to execute each task, coordinating their movements and actions to achieve the desired swarm behavior.

Throughout the execution of the method 800, the autonomous ground vehicles may continuously monitor their environment and communicate with each other. This ongoing communication and sensing may allow the swarm to adapt to changing conditions, avoid obstacles, and maintain the desired formation or behavior. The method 800 may also include feedback loops, allowing for real-time adjustments to task assignments or constraint parameters as needed to optimize the swarm's performance and achieve the objectives specified in the initial multi-agent behavior request.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations are not intended to convey that the claimed subject matter requires features or combinations of features other than those expressly recited in the claims. Accordingly, the scope of this disclosure is intended to include all modifications and variations encompassed within the spirit and scope of the following appended claims.

1. An autonomous ground vehicle system configured to be deployed in and coordinate with a multi-agent swarm of autonomous ground vehicles, the autonomous ground vehicle system comprising:
one or more processors;
one or more memories;
one or more wireless communication modules;
one or more motors; and
one or more sensors configured to observe an environment through which the autonomous ground vehicle system navigates;
wherein the system is configured to:
receive, via the one or more wireless communication modules, a multi-agent behavior request, the multi-agent behavior request requiring multiple agents to be performed;
translate the multi-agent behavior request into one or more tasks, each of the one or more tasks being configured to be performed by a single agent;
assign at least a first task of the one or more tasks to the autonomous ground vehicle system based, at least in part, on a cost function indicating that the first task is configured to be performed by the autonomous ground vehicle system more efficiently than by another agent in the multi-agent swarm of autonomous ground vehicles; and
autonomously execute the first task, wherein autonomously executing the first task causes the autonomous ground vehicle system to navigate through the environment using the one or more sensors and the one or more motors.

2. The autonomous ground vehicle system of claim 1, wherein the system is further configured to:
translate the multi-agent behavior request into one or more constraints; and
autonomously execute the first task while adhering to the one or more constraints.

3. The autonomous ground vehicle system of claim 1, wherein the system is further configured to translate the multi-agent behavior request by:
selecting a translation algorithm from a plurality of translation algorithms based on the multi-agent behavior request; and
applying the selected translation algorithm to generate the one or more tasks.

4. The autonomous ground vehicle system of claim 1, wherein the system is further configured to translate the multi-agent behavior request by:
selecting a translation algorithm from a plurality of translation algorithms based on the multi-agent behavior request; and
applying the selected translation algorithm to generate one or more constraints.

5. The autonomous ground vehicle system of claim 1, wherein the translation of the multi-agent behavior request into the one or more tasks is performed by each agent in the multi-agent swarm of autonomous ground vehicles, and wherein each agent in the multi-agent swarm of autonomous ground vehicles obtains the same result of translating the multi-agent behavior request into the one or more tasks.

6. The autonomous ground vehicle system of claim 1, wherein the cost function comprises:
each agent in the multi-agent swarm of autonomous ground vehicles making a bid on each task of the one or more tasks;
communicating the bids between each agent in the multi-agent swarm of autonomous ground vehicles; and
resolving conflicts to assign each task of the one or more tasks to one or more of the agents in the multi-agent swarm of autonomous ground vehicles.

7. The autonomous ground vehicle system of claim 6, wherein each agent in the multi-agent swarm of autonomous ground vehicles making a bid on each task of the one or more tasks comprises calculating a score for each task of the one or more tasks.

8. The autonomous ground vehicle system of claim 7, wherein the score for each task of the one or more tasks is further based on capabilities of each respective autonomous ground vehicle of the multi-agent swarm of autonomous ground vehicles.

9. The autonomous ground vehicle system of claim 6, wherein the multi-agent swarm of autonomous ground vehicles includes at least a first autonomous ground vehicle and a second autonomous ground vehicle, wherein the second autonomous ground vehicle has at least one different capability relative to the first autonomous ground vehicle, and wherein making a bid on each task of the one or more tasks comprises accounting for the at least one different capability when calculating the bid for one or more of the tasks.

10. The autonomous ground vehicle system of claim 1, wherein the system is further configured to autonomously execute the first task by:
querying a navigation stack to determine navigation instructions for completing the first task; and
providing the navigation instructions to the autonomous ground vehicle system to execute the first task.

11. A method for operating an autonomous ground vehicle system configured to be deployed in and coordinate with a multi-agent swarm of autonomous ground vehicles, the method comprising:
receiving, via one or more wireless communication modules, a multi-agent behavior request, the multi-agent behavior request requiring multiple agents to be performed;
translating the multi-agent behavior request into one or more tasks, each of the one or more tasks being configured to be performed by a single agent;
assigning at least a first task of the one or more tasks to the autonomous ground vehicle system based, at least in part, on a cost function indicating that the first task is configured to be performed by the autonomous ground vehicle system more efficiently than by another agent in the multi-agent swarm of autonomous ground vehicles; and
autonomously executing the first task, wherein autonomously executing the first task causes the autonomous ground vehicle system to navigate through an environment using one or more sensors and one or more motors.

12. The method of claim 11, further comprising:
translating the multi-agent behavior request into one or more constraints; and
autonomously executing the first task while adhering to the one or more constraints.

13. The method of claim 11, wherein translating the multi-agent behavior request comprises:
selecting a translation algorithm from a plurality of translation algorithms based on the multi-agent behavior request; and
applying the selected translation algorithm to generate the one or more tasks.

14. The method of claim 11, wherein translating the multi-agent behavior request comprises:
selecting a translation algorithm from a plurality of translation algorithms based on the multi-agent behavior request; and
applying the selected translation algorithm to generate one or more constraints.

15. The method of claim 11, wherein the translation of the multi-agent behavior request into the one or more tasks is performed by each agent in the multi-agent swarm of autonomous ground vehicles, and wherein each agent in the multi-agent swarm of autonomous ground vehicles obtains the same result of translating the multi-agent behavior request into the one or more tasks.

16. The method of claim 11, wherein the cost function comprises:
each agent in the multi-agent swarm of autonomous ground vehicles making a bid on each task of the one or more tasks;
communicating the bids between each agent in the multi-agent swarm of autonomous ground vehicles; and
resolving conflicts to assign each task of the one or more tasks to one or more of the agents in the multi-agent swarm of autonomous ground vehicles.

17. The method of claim 16, wherein each agent in the multi-agent swarm of autonomous ground vehicles making a bid on each task of the one or more tasks comprises calculating a score for each task of the one or more tasks.

18. The method of claim 17, wherein the score for each task of the one or more tasks is further based on capabilities of each respective autonomous ground vehicle of the multi-agent swarm of autonomous ground vehicles.

19. The method of claim 16, wherein the multi-agent swarm of autonomous ground vehicles includes at least a first autonomous ground vehicle and a second autonomous ground vehicle, wherein the second autonomous ground vehicle has at least one different capability relative to the first autonomous ground vehicle, and wherein making a bid on each task of the one or more tasks comprises accounting for the at least one different capability when calculating the bid for one or more of the tasks.

20. The method of claim 11, wherein autonomously executing the first task comprises:
querying a navigation stack to determine navigation instructions for completing the first task; and
providing the navigation instructions to the autonomous ground vehicle system to execute the first task.
